(19) United States
(12) Patent Application Publication
(10) Pub. No.: US 2026/0264599 A1
(43) Pub. Date: Sep. 10, 2026

(54) VEHICLE LAMP SYSTEM, CONTROL DEVICE, AND STORAGE MEDIUM

(71) Applicant: KOITO MANUFACTURING CO., LTD., Tokyo (JP)

(72) Inventor: Akinori MATSUMOTO, Shizuoka (JP)

(21) Appl. No.: 19/555,888

(22) Filed: Mar. 4, 2026

(30) Foreign Application Priority Data
Mar. 10, 2025 (JP) 2025-037145

(51) Int. Cl. B60Q 1/076

(52) U.S. Cl. CPC B60Q 1/076; B60Q 2200/30; B60Q 2300/116; B60Q 2300/32

(57) ABSTRACT

A vehicle lamp system includes a low-beam unit capable of forming a low-beam light distribution pattern having a traveling-lane-side cutoff line, a position of which in a vehicle width direction overlaps with a traveling lane TL of a host vehicle, and a control device that controls the light irradiation by the low-beam unit. The control device controls the low-beam unit such that the traveling-lane-side cutoff line is set to a first height while the host vehicle is stopped, and the traveling-lane-side cutoff line is set to a second height higher than the first height while the host vehicle is traveling on a straight road.

### CROSS-REFERENCE TO RELATED APPLICATIONS

This application is based on and claims priority from Japanese Patent Application No. 2025-037145, filed on Mar. 10, 2025, with the Japan Patent Office, the disclosure of which is incorporated herein in its entirety by reference.

### TECHNICAL FIELD

The present disclosure relates to a vehicle lamp system, a control device, and a storage medium.

### BACKGROUND

A vehicle lamp plays an important role in a safe traveling at night or in tunnels. When the area in front of a vehicle is brightly and widely illuminated in favor of the driver's visibility, there is a problem in that glare is caused to the drivers of the vehicles ahead such as preceding vehicles and oncoming vehicles. In this regard, conventional vehicle lamps have reduced glare given to the drivers of vehicles ahead by forming a low-beam light distribution pattern having a cutoff line (see, e.g., Japanese Patent Laid-Open Publication No. 2012-134091).

### SUMMARY

In recent years, an autonomous emergency braking (AEB, also referred to as a collision damage mitigation braking) has increasingly been installed in vehicles as a vehicle driving assistance function. In the AEB, an imaging device mounted on a vehicle detects a target moving object such as a pedestrian that may collide with the host vehicle. Then, when the target moving object is detected, a braking is automatically applied. As a result of intensive studies conducted by the inventors of the present disclosure on detection of a target moving object by an imaging device, it has been found that there is room for improving the detection accuracy of the target moving object under formation of a low-beam light distribution pattern and that an improvement in such detection accuracy may enhance the accuracy of vehicle driving assistance.

The present disclosure has been made in view of the above circumstances, and one of objects thereof is to provide a technology for improving the accuracy of vehicle driving assistance.

In order to address the above issue, an aspect of the present disclosure is a vehicle lamp system. The vehicle lamp system includes a low-beam unit capable of forming a low-beam light distribution pattern having a traveling-lane-side cutoff line, a position of which in a vehicle width direction overlaps with a traveling lane of a host vehicle, and a control device configured to control the light irradiation by the low-beam unit. The control device controls the low-beam unit such that the traveling-lane-side cutoff line is set to a first height while the host vehicle is stopped, and the traveling-lane-side cutoff line is set to a second height higher than the first height while the host vehicle is traveling on a straight road.

Further, another aspect of the present disclosure is a control device configured to control the light irradiation by a low-beam unit capable of forming a low-beam pattern having a traveling-lane-side cutoff line, a position of which in a vehicle width direction overlaps with a traveling lane of a host vehicle. The control device controls the low-beam unit such that the traveling-lane-side cutoff line is set to a first height while the host vehicle is stopped, and the traveling-lane-side cutoff line is set to a second height higher than the first height while the host vehicle is traveling on a straight road.

Further, yet another aspect of the present disclosure is a non-transitory computer-readable storage medium having stored therein a computer program executed by a control device that controls light irradiation by a low-beam unit capable of forming a low-beam light distribution pattern having a traveling-lane-side cutoff line, a position of which in a vehicle width direction overlaps with a traveling lane of a host vehicle. The computer program causes the control device to execute a function of controlling the low-beam unit such that the traveling-lane-side cutoff line is set to a first height while the host vehicle is stopped, and the traveling-lane-side cutoff line is set to a second height higher than the first height while the host vehicle is traveling on a straight road.

In addition, any combination of the components described above and changes in expressions of the present disclosure, for example, a method, a device, and a system, are also effective as aspects of the present disclosure.

According to the present disclosure, it is possible to improve the accuracy of vehicle driving assistance.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating a schematic configuration of a vehicle lamp system according to Embodiment 1.

FIG. 2 is a schematic diagram illustrating light distribution patterns that may be formed by respective units.

FIGS. 3A and 3B are schematic diagrams illustrating an example of light distribution control.

FIG. 4 is a flowchart illustrating an example of light distribution control.

FIG. 5 is a diagram illustrating a schematic configuration of a vehicle lamp system according to Embodiment 2.

FIGS. 6A and 6B are schematic diagrams illustrating an example of light distribution control.

### DETAILED DESCRIPTION

In the following detailed description, reference is made to the accompanying drawings which form a part hereof. The illustrative embodiments described in the detailed description, drawings, and claims are not meant to be limiting. Other embodiments may be utilized, and other changes may be made without departing from the spirit or scope of the subject matter presented herein.

Hereinafter, the present disclosure will be described with reference to the drawings based on suitable embodiments. The embodiments are illustrative and are not intended to limit the present disclosure, and all features described in the embodiments and combinations thereof are not necessarily essential to the present disclosure. The same or equivalent components, members, and processes illustrated in the respective drawings are denoted by the same reference numerals, and redundant descriptions thereof will be omitted as appropriate. Further, the scales and shapes of respective parts illustrated in the respective drawings are set forth schematically for ease of description, and are not to be construed as limiting unless otherwise stated. Further, when terms such as “first” and “second” are used in this specification or claims, these terms do not indicate any order or importance unless otherwise stated, but are used merely to distinguish one component from another. Further, some members that are less relevant to describe the embodiments are omitted in the respective drawings.

### EMBODIMENT 1

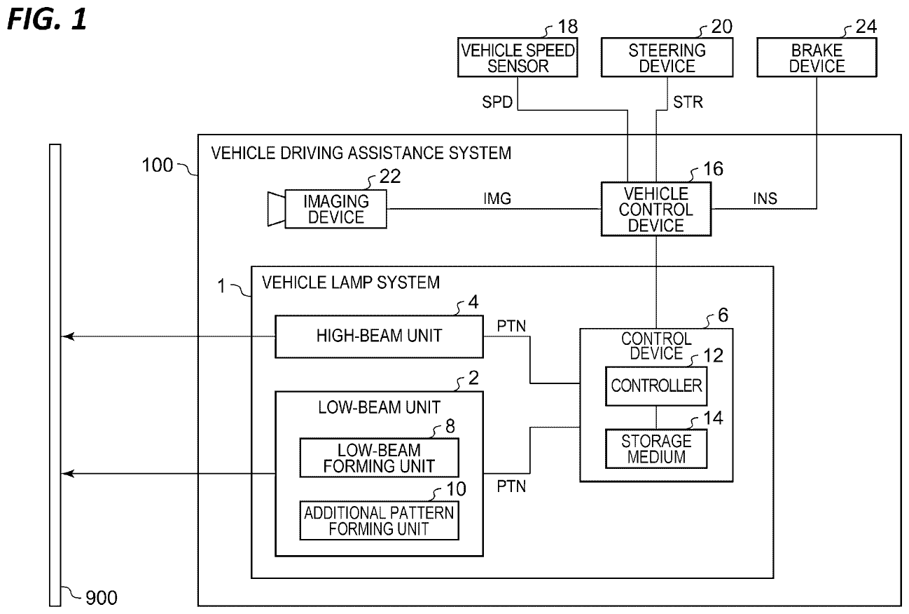

FIG. 1 is a diagram illustrating a schematic configuration of a vehicle lamp system 1 according to Embodiment 1. In FIG. 1, at least some of components of the vehicle lamp system 1 are illustrated as functional blocks. These functional blocks are implemented, in terms of hardware, by elements and circuits such as a computer CPU and a memory, and are implemented, in terms of software, by computer programs and other similar components. It will be understood by those skilled in the art that these functional blocks may be implemented in various forms by combinations of hardware and software.

The vehicle lamp system 1 of the present embodiment mainly includes a low-beam unit 2, a high-beam unit 4, and a control device 6.

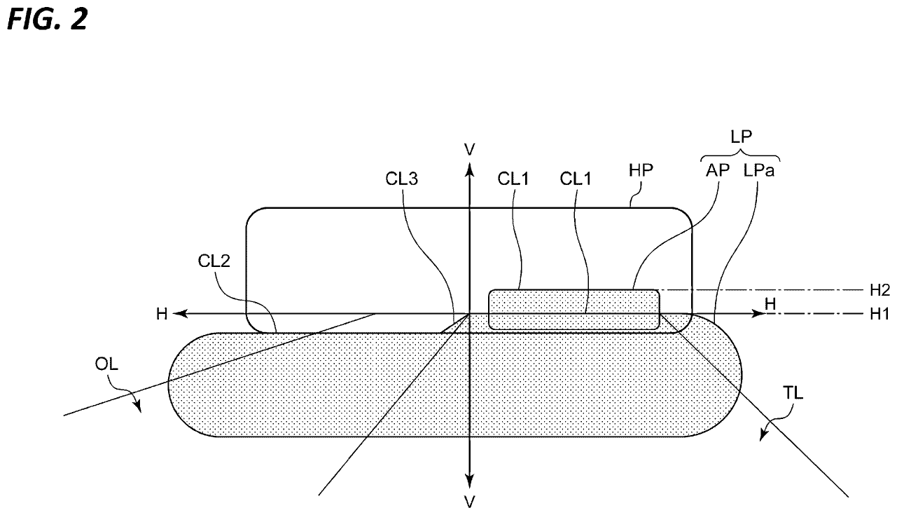

The low-beam unit 2 and the high-beam unit 4 are each capable of emitting visible light forward of a host vehicle to form a specific light distribution pattern. FIG. 2 is a schematic diagram illustrating light distribution patterns that may be formed by the respective units. Each light distribution pattern is understood as a two-dimensional illuminance distribution of an irradiation pattern formed by the corresponding unit on a virtual vertical screen 900 positioned in front of the host vehicle. In addition, FIG. 2 illustrates, as an example, a low-beam light distribution pattern LP for right-hand traffic.

The low-beam unit 2 is capable of forming the low-beam light distribution pattern LP having a traveling-lane-side cutoff line CL1, the position of which in the vehicle width direction overlaps with a traveling lane TL (own lane) of the host vehicle. The low-beam unit 2 of the present embodiment includes a low-beam forming unit 8 and an additional pattern forming unit 10.

The low-beam forming unit 8 forms a reference low-beam light distribution pattern LPa having the traveling-lane-side cutoff line CL1 positioned at a first height H1. The reference low-beam light distribution pattern LPa has the same shape as that of a known low-beam light distribution pattern. That is, as an example, the reference low-beam light distribution pattern LPa includes a diffusion pattern that spreads in the vehicle width direction below an H-H line, and the traveling-lane-side cutoff line CL1 that is positioned at the top of a region of the diffusion pattern overlapping with the traveling lane TL to extend parallel to the H-H line, for example, in the vehicle width direction. The first height H1 at which the traveling-lane-side cutoff line CL1 is positioned corresponds, for example, to the H-H line.

Further, the reference low-beam light distribution pattern LPa includes, in addition to the traveling-lane-side cutoff line CL1, an opposing-lane-side cutoff line CL2 extending in the vehicle width direction and positioned at the top of a region of the diffusion pattern overlapping with an opposing lane OL. Furthermore, the reference low-beam light distribution pattern LPa has an oblique cutoff line CL3 that interconnects the traveling-lane-side cutoff line CL1 and the opposing-lane-side cutoff line CL2. The opposing-lane-side cutoff line CL2 is positioned lower than the traveling-lane-side cutoff line CL1. In addition, the term “cutoff line” refers to a boundary line between a bright region and a dark region in the low-beam light distribution pattern LP.

The structure of the low-beam forming unit 8 is not particularly limited, as long as it is capable of forming the reference low-beam light distribution pattern LPa. For example, the low-beam forming unit 8 may employ a known lamp structure that includes a light source, optical members such as a reflector and a projection lens for directing light from the light source forward of the vehicle, and a shade member having a ridge corresponding to the shape of each cutoff line and configured to block a part of the light directed from the light source forward of the vehicle. The light source mounted in the low-beam forming unit 8 may be a semiconductor light source such as a light emitting diode (LED), a laser diode (LD), or an organic or inorganic electroluminescence (EL), or may be an incandescent bulb, a halogen lamp, or a discharge bulb, among others.

The additional pattern forming unit 10 forms an additional light distribution pattern AP having the traveling-lane-side cutoff line CL1 positioned at a second height H2 higher than the first height H1. In the present embodiment, the additional light distribution pattern AP has a substantially rectangular shape elongated in the vehicle width direction, and as an example, is entirely positioned on the traveling lane TL side of the V-V line, and overlaps with the traveling-lane-side cutoff line CL1 of the reference low-beam light distribution pattern LPa. Further, at least a part of the additional light distribution pattern AP is positioned above the H-H line, in other words, above the first height H1. An upper end of the additional light distribution pattern AP constitutes the traveling-lane-side cutoff line CL1 positioned at the second height H2. The second height H2 is, for example, at a position lower than an upper end of a high-beam light distribution pattern HP, and is located within a range of up to a +2.5° when an angle corresponding to the first height H1 is defined as a °.

The structure of the additional pattern forming unit 10 is not particularly limited, as long as it is capable of forming the additional light distribution pattern AP. For example, the additional pattern forming unit 10 may employ a known lamp structure that includes a light source and an optical member such as a projection lens for directing light from the light source forward of the vehicle. The light source mounted in the additional pattern forming unit 10 is the same as that of the low-beam forming unit 8.

The low-beam light distribution pattern LP is formed either solely by the reference low-beam light distribution pattern LPa, or by combining the reference low-beam light distribution pattern LPa with the additional light distribution pattern AP.

The high-beam unit 4 is capable of forming the high-beam light distribution pattern HP in a region above the respective cutoff lines. As an example, the high-beam light distribution pattern HP has a lower end overlapping with the opposing-lane-side cutoff line CL2, and spreads upward beyond the H-H line. Since the structure of the high-beam unit 4 is well known, the detailed description and illustration thereof are omitted.

The low-beam unit 2, the high-beam unit 4, the low-beam forming unit 8, and the additional pattern forming unit 10 are accommodated in the same lighting chamber as an example, but are not particularly limited to this configuration and may be accommodated in separate lighting chambers. Further, the respective units and the respective formers may be physically independent of one another, or may share a part of the structure, for example, such that the respective light sources are mounted on a single substrate, or light from the respective light sources pass through a single projection lens.

The control device 6 transmits signals instructing the low-beam unit 2 and the high-beam unit 4 to form a light distribution pattern PTN, thereby controlling the light irradiation by each unit. As an example, the control device 6 is configured with a lamp electronic control unit (ECU), and may be accommodated in the same lighting chamber as that of the respective units. Further, the control device 6 may be configured with a digital processor, and may be constituted, for example, by a combination of a microcomputer including a central processing unit (CPU) and a software program. In addition, the control device 6 may be configured with a field programmable gate array (FPGA) or an application specific IC (ASIC).

The control device 6 includes a controller 12 configured with, for example, a CPU, and a storage medium 14 configured with a memory or a storage. The storage medium 14 stores, for example, a computer program to be executed by the control device 6, more specifically, by the controller 12. The controller 12 operates in the manner that the integrated circuits constituting the controller 12 execute the program stored in the storage medium 14.

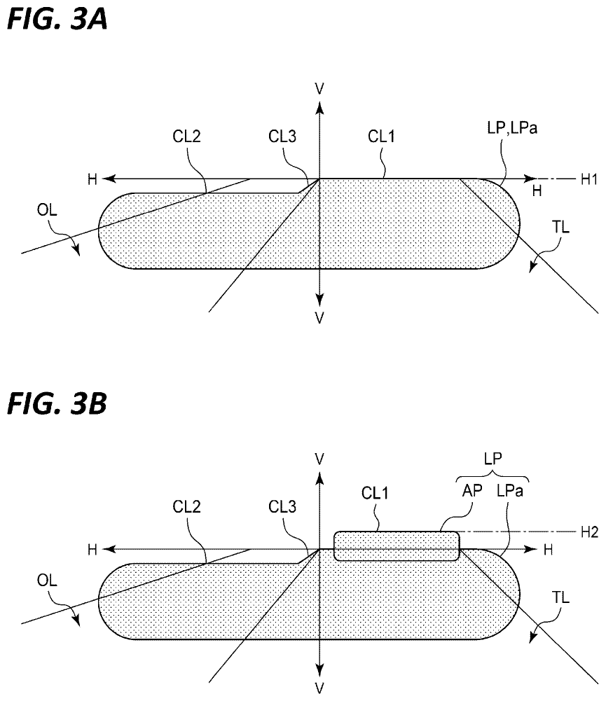

FIGS. 3A and 3B are schematic diagrams illustrating an example of light distribution control. FIG. 3A illustrates the low-beam light distribution pattern LP formed while the host vehicle is stopped. FIG. 3B illustrates the low-beam light distribution pattern LP formed while the host vehicle is traveling on a straight road. The control device 6 controls the low-beam unit 2 such that the traveling-lane-side cutoff line CL1 is set to the first height H1 while the host vehicle is stopped, and the traveling-lane-side cutoff line CL1 is set to the second height H2 while the host vehicle is traveling on a straight road.

For example, the control device 6 may acquire a vehicle speed signal SPD indicating the vehicle speed information from a vehicle speed sensor 18 mounted on the vehicle via a vehicle control device 16 mounted on the vehicle. Further, the control device 6 may also receive, via the vehicle control device 16, a steering angle signal STR indicating steering angle information from a steering device 20 mounted on the vehicle. The vehicle control device 16 is configured, for example, with a vehicle ECU (also referred to as an in-vehicle ECU) and is mounted on the vehicle body. In addition, the control device 6 may directly receive signals from the vehicle speed sensor 18 and the steering device 20. By receiving a vehicle speed signal SPD, the control device 6 may determine whether the host vehicle is stopped or traveling. For example, the control device 6 determines that the vehicle is stopped when the vehicle speed is zero. Further, by receiving a steering angle signal STR, the control device 6 may determine whether the host vehicle is traveling on a straight road. For example, the control device 6 determines that the host vehicle is traveling on a straight road when the steering angle is, for example, ±5° or less. Whether the host vehicle is traveling on a straight road may also be determined based on, for example, an image IMG captured by an imaging device 22 to be described later, or based on information from a navigation system (not illustrated).

In the present embodiment, the control device 6 controls the low-beam forming unit 8 to form the reference low-beam light distribution pattern LPa while the host vehicle is stopped and while the host vehicle is traveling. Further, the control device 6 controls the additional pattern forming unit 10 such that the additional light distribution pattern AP is not formed while the host vehicle is stopped, and the additional light distribution pattern AP is formed while the host vehicle is traveling on a straight road. In addition, “the additional light distribution pattern AP is not formed” in the present disclosure includes even a case in which the additional light distribution pattern AP is formed with light of a low illuminance that it is not visually recognizable by a person or is not captured by an imaging device.

As a result, while the host vehicle is stopped, the low-beam light distribution pattern LP composed only of the reference low-beam light distribution pattern LPa is formed in front of the host vehicle, as illustrated in FIG. 3A. Therefore, the traveling-lane-side cutoff line CL1 is at the first height H1. Meanwhile, while the host vehicle is traveling on a straight road, the low-beam light distribution pattern LP composed of the reference low-beam light distribution pattern LPa and the additional light distribution pattern AP is formed in front of the host vehicle, as illustrated in FIG. 3B. Therefore, the traveling-lane-side cutoff line CL1 is at the second height H2.

The control device 6 may control the low-beam unit 2 such that the traveling-lane-side cutoff line CL1 is set to the second height H2 when the host vehicle is traveling on a straight road and no preceding vehicle is present. This may more reliably suppress the risk of causing glare to a preceding vehicle. For example, the control device 6 may determine the presence or absence of a preceding vehicle by using the image IMG generated by the imaging device 22 to be described later, based on a known determination method including, for example, image binarization processing. Further, the presence or absence of a preceding vehicle may be determined, for example, by the vehicle control device 16 or an imaging control device to be described later. In this case, the control device 6 may recognize the presence or absence of a preceding vehicle by acquiring a determination result from, for example, the vehicle control device 16. In addition, the control device 6 may control the low-beam unit 2 such that the traveling-lane-side cutoff line CL1 is set to the second height H2 while the host vehicle is traveling on a straight road and neither a preceding vehicle or an oncoming vehicle is present. As an example, the preceding vehicle is a vehicle traveling in front of the host vehicle in the traveling lane TL, and the oncoming vehicle is a vehicle traveling in front of the host vehicle in the opposing lane OL.

In addition, the additional light distribution pattern AP is entirely formed on the traveling lane TL side of the V-V line and does not overlap with the opposing lane OL. Therefore, adding the additional light distribution pattern AP to the reference low-beam light distribution pattern LPa differs from adding the high-beam light distribution pattern HP to the reference low-beam light distribution pattern LPa. Further, whether or not the additional light distribution pattern AP is formed includes, as a switching condition, whether the host vehicle is traveling on a straight road. Therefore, adding the additional light distribution pattern AP to the reference low-beam light distribution pattern LPa differs from the adaptive driving beam (ADB) control, in which a part of the high-beam light distribution pattern HP is shielded according to the presence of vehicles ahead including preceding vehicles and oncoming vehicles, regardless of whether the host vehicle is traveling on a straight road.

As illustrated in FIG. 1, as an example, the vehicle lamp system 1 is incorporated into a vehicle driving assistance system 100. The vehicle driving assistance system 100 includes the vehicle lamp system 1, the vehicle control device 16, and the imaging device 22.

The imaging device 22 is, for example, an in-vehicle camera that has sensitivity in a visible light region and repeatedly captures images of an area the front of the host vehicle at a predetermined cycle. The imaging device 22 captures visible light emitted from the low-beam unit 2 and the high-beam unit 4 and reflected by an object located in front of the vehicle. Further, the imaging device 22 captures light emitted by a vehicle ahead, as well as light emitted by a self-luminous object such as a streetlight or an electronic bulletin board. In addition, when the condition for setting the traveling-lane-side cutoff line CL1 to the second height H2 includes the presence or absence of a preceding vehicle, the imaging device 22 may be regarded as a component of the vehicle lamp system 1.

The image IMG generated by the imaging device 22 is transmitted to the vehicle control device 16. The image IMG acquired by the vehicle control device 16 from the imaging device 22 may be RAW image data, or may be image data that has undergone predetermined image processing by the imaging device 22.

The vehicle control device 16 controls various operations of the vehicle. The vehicle control device 16 may be configured with a digital processor, and may be constituted, for example, by a combination of a microcomputer including a CPU and a software program. In addition, the vehicle control device 16 may be configured with, for example, an FPGA or an ASIC. The vehicle control device 16 outputs various instructions to devices mounted on the vehicle such as a brake device 24. The brake device 24 executes a braking operation.

When the vehicle control device 16 detects that a predetermined target moving object is present in a region of the image IMG, the position of which in the vehicle width direction overlaps with the traveling lane TL, the vehicle control device 16 transmits a predetermined driving assistance instruction signal INS. The target moving object refers to a moving object such as a pedestrian, a bicycle, or an animal that is expected to interfere with the traveling of the host vehicle, for example, a moving object for which it is necessary to perform driving assistance for the host vehicle. As an example, the driving assistance instruction signal INS includes a braking instruction signal to the brake device 24. The brake device 24 executes a braking operation upon receiving the driving assistance instruction signal INS transmitted from the vehicle control device 16. Thereby, an automatic emergency braking may be implemented.

The vehicle control device 16 may detect the target moving object by performing known object detection processing on the image IMG. The object detection processing includes, for example, predetermined image processing, algorithm-based recognition, and deep learning.

Here, it is assumed that the target moving object is present within a range extending across the traveling-lane-side cutoff line CL1 from above to below. When only the reference low-beam light distribution pattern LPa is formed, a region where the reference low-beam light distribution pattern LPa is formed has sufficient brightness for imaging by the imaging device 22. Therefore, a portion of the target moving object located in front of the host vehicle that is included in that region is clearly captured in the image IMG to an extent that allows determination of the presence and shape of the target moving object. However, a portion of the target moving object located above the cutoff line CL is highly likely not to be captured in the image IMG to an extent that allows determination of the presence and shape of the target moving object.

Accordingly, in a situation where only the reference low-beam light distribution pattern LPa is formed, the vehicle control device 16 may not recognize the entire target moving object when object detection processing is performed on the image IMG. Therefore, it is difficult to determine whether an object present in front of the host vehicle is the target moving object.

In contrast, while the host vehicle is traveling on a straight road, the control device 6 adds the additional light distribution pattern AP to the reference low-beam light distribution pattern LPa, thereby setting the height of the traveling-lane-side cutoff line CL1 to be higher than that while the host vehicle is stopped. This makes it possible to clearly capture a wider range of the target moving object even when the target moving object extends above the traveling-lane-side cutoff line CL1. Accordingly, it is possible to determine, with higher accuracy, whether the target moving object is present in the traveling lane TL.

Further, the control device 6 avoids forming the additional light distribution pattern AP while the host vehicle is stopped. This makes it possible to reduce the risk of unnecessarily causing glare to other traffic participants. Further, the control device 6 avoids forming the additional light distribution pattern AP when the traveling lane TL is not straight even while the host vehicle is traveling. This makes it possible to reduce the risk of causing glare to vehicles ahead, including preceding vehicles and oncoming vehicles.

As an example, no switch is provided for switching between execution and non-execution of the above-described light distribution control. Accordingly, the control device 6 always executes the above-described light distribution control while an instruction to form the low-beam light distribution pattern LP is being issued. This makes it possible to avoid a situation in which the above-described light distribution control is not executed due to the driver forgetting to turn on a switch.

The detection of the target moving object may be executed by the control device 6. Further, when the imaging device 22 is provided with an imaging control device such as a camera ECU, the imaging control device may detect the target moving object. When the imaging control device detects the target moving object, it is possible to avoid control delay caused by transmission of the image IMG from the camera ECU to the vehicle ECU. Further, the driving assistance instruction signal INS may be transmitted by the control device 6 or by the imaging control device.

The present embodiment includes a computer program executed by the control device 6. The computer program causes the control device 6 to execute a function of controlling the low-beam unit 2 such that the traveling-lane-side cutoff line CL1 is set to the first height H1 while the host vehicle is stopped, and the traveling-lane-side cutoff line CL1 is set to the second height H2 higher than the first height H1 while the host vehicle is traveling on a straight road. Further, the present embodiment also includes the storage medium 14 storing the computer program.

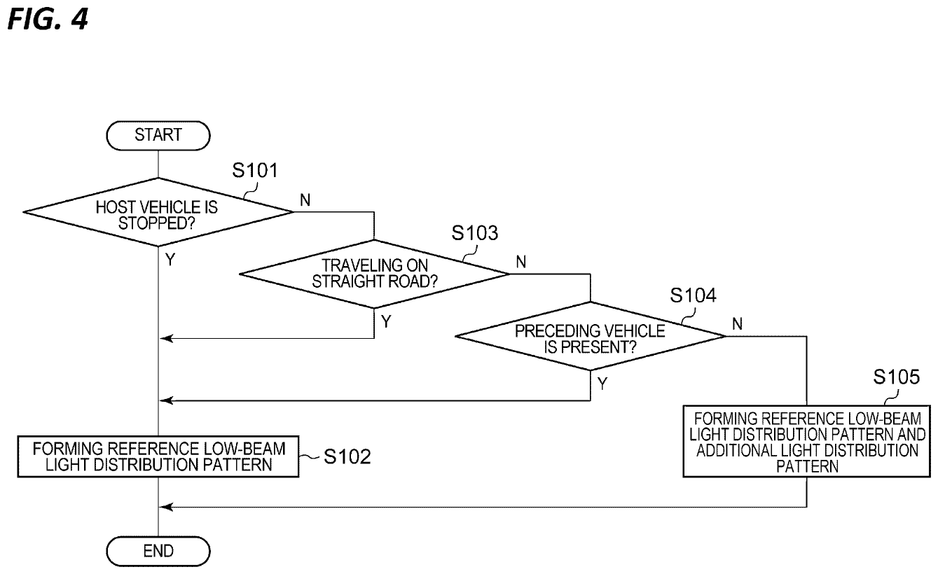

FIG. 4 is a flowchart illustrating an example of the light distribution control executed by the control device 6. This flow is repeatedly executed at a predetermined timing, for example, in a situation in which formation of the low-beam light distribution pattern LP is instructed by a light switch. First, the control device 6 determines whether the host vehicle is stopped (S101). When it is determined that the host vehicle is stopped (Y in S101), the control device 6 controls the low-beam unit 2 to form the reference low-beam light distribution pattern LPa (S102), and then, ends this routine.

When it is determined that the host vehicle is not stopped, that is, while the host vehicle is traveling (N in S101), the control device 6 determines whether the host vehicle is traveling on a straight road (S103). When it is determined that the host vehicle is not traveling on a straight road (N in S103), the control device 6 controls the low-beam unit 2 to form the reference low-beam light distribution pattern LPa (S102), and then, ends this routine. When it is determined that the host vehicle is traveling on a straight road (Y in S103), the control device 6 determines whether a preceding vehicle is present (S104). When it is determined that a preceding vehicle is present (Y in S104), the control device 6 controls the low-beam unit 2 to form the reference low-beam light distribution pattern LPa (S102), and then, ends this routine. When it is determined that no preceding vehicle is present (N in S104), the control device 6 controls the low-beam unit 2 to form the reference low-beam light distribution pattern LPa and the additional light distribution pattern AP (S105), and ends this routine. In addition, the determination as to the presence or absence of a preceding vehicle may be performed before the determination as to whether the host vehicle is traveling on a straight road.

As described above, in the vehicle lamp system 1 according to the present embodiment, the control device 6 controls the low-beam unit 2 such that the traveling-lane-side cutoff line CL1 is set to the first height H1 while the host vehicle is stopped, and the traveling-lane-side cutoff line CL1 is set to the second height H2 higher than the first height H1 while the host vehicle is traveling on a straight road. Thereby, the detection accuracy of the target moving object under formation of the low-beam light distribution pattern LP may be enhanced. Accordingly, the accuracy of vehicle driving assistance may be improved. Further, the safety of vehicle traveling may be enhanced since the driver may more easily visually recognize the target moving object.

Further, the low-beam unit 2 of the present embodiment includes the low-beam forming unit 8 that forms the reference low-beam light distribution pattern LPa, and the additional pattern forming unit 10 that forms the additional light distribution pattern AP. Then, the control device 6 raises the traveling-lane-side cutoff line CL1 from the first height H1 to the second height H2 by adding the additional light distribution pattern AP to the reference low-beam light distribution pattern LPa. Thereby, the detection accuracy of the target moving object may be enhanced with a simple lamp structure, and thus, an increase in cost may be prevented.

### EMBODIMENT 2

The configuration of a vehicle lamp system 1 according to Embodiment 2 is substantially common to the configuration of the vehicle lamp system 1 according to Embodiment 1, except for the structure of the low-beam unit 2. Hereinafter, the vehicle lamp system 1 according to Embodiment 2 will be described mainly with respect to configurations different from those of Embodiment 1, and configurations common to Embodiment 1 will be briefly described or omitted.

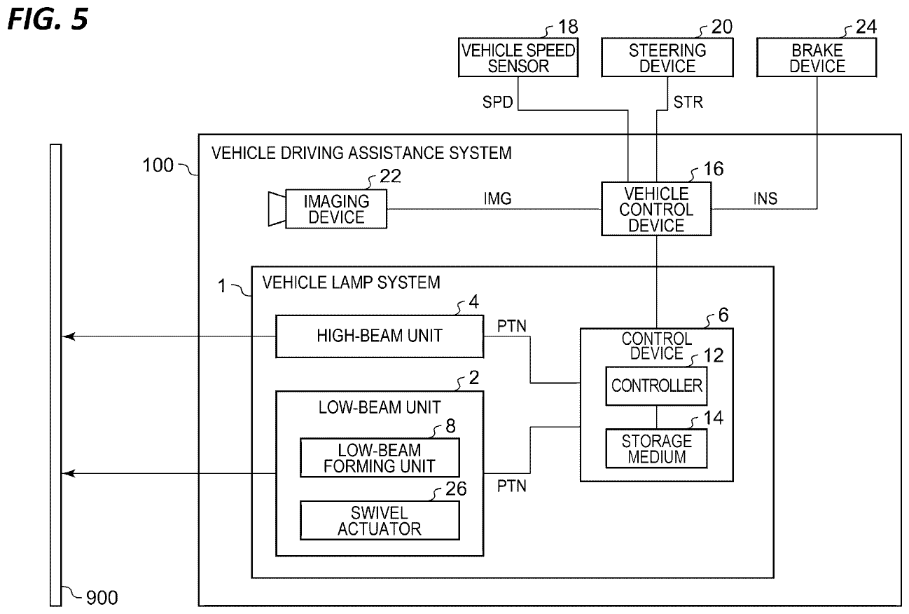

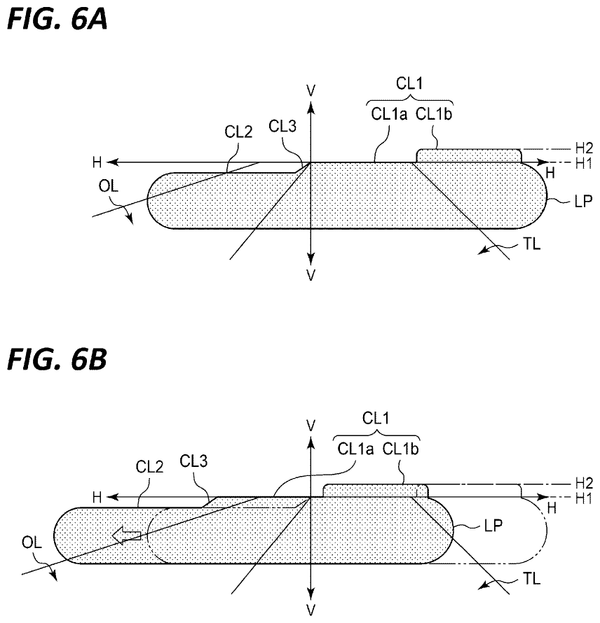

FIG. 5 is a diagram illustrating a schematic configuration of the vehicle lamp system 1 according to Embodiment 2. In FIG. 5, at least some of components of the vehicle lamp system 1 are illustrated as functional blocks, as in FIG. 1. FIGS. 6A and 6B are schematic diagrams illustrating an example of light distribution control. FIG. 6A illustrates the low-beam light distribution pattern LP formed while the host vehicle is stopped. FIG. 6B illustrates the low-beam light distribution pattern LP formed while the host vehicle is traveling on a straight road.

In the present embodiment, as illustrated in FIG. 5, the low-beam unit 2 includes a swivel actuator 26 that displaces the light irradiation direction of the low-beam forming unit 8 in the vehicle width direction, instead of the additional pattern forming unit 10. Further, as illustrated in FIG. 6A, the low-beam forming unit 8 of the present embodiment forms the low-beam light distribution pattern LP having the traveling-lane-side cutoff line CL1 that includes a first portion CL1a and a second portion CL1b. The first portion CL1a is positioned at the first height and extends in the vehicle width direction. The second portion CL1b is shifted from the first portion CL1a in the vehicle width direction, is positioned at the second height H2, and extends in the vehicle width direction. As an example, the second portion CL1b is positioned outward in the vehicle width direction relative to the first portion CL1a when the low-beam light distribution pattern LP is formed while the host vehicle is stopped. The traveling-lane-side cutoff line CL1 including the first portion CL1a and the second portion CL1b may be formed, for example, by providing the ridge of a shade member with a shape corresponding to the first portion CL1a and the second portion CL1b.

In the present embodiment, as illustrated in FIG. 6A, the control device 6 controls the swivel actuator 26 such that the position of the first portion CL1a in the vehicle width direction overlaps with the traveling lane TL while the host vehicle is stopped. Further, as illustrated in FIG. 6B, the control device 6 controls the swivel actuator 26 such that the position of the second portion CL1b in the vehicle width direction overlaps with the traveling lane TL while the host vehicle is traveling on a straight road.

That is, the low-beam unit 2 forms the traveling-lane-side cutoff line CL1 having the first portion CL1a and the second portion CL1b, both while the host vehicle is stopped and while the host vehicle is traveling. The control device 6 determines the light irradiation direction of the low-beam unit 2 such that the first portion CL1a overlaps with the traveling lane TL while the host vehicle is stopped. Then, the control device 6 swivels the low-beam unit 2 by the swivel actuator 26 to move the second portion CL1b to a position overlapping with the traveling lane TL while the host vehicle transitions to traveling on a straight road. Accordingly, the traveling-lane-side cutoff line CL1 may be set to the first height H1 while the host vehicle is stopped, and the traveling-lane-side cutoff line CL1 may be set to the second height H2 while the host vehicle is traveling on a straight road. In addition, the control device 6 may control the swivel actuator 26 such that the position of the second portion CL1b in the vehicle width direction overlaps with the traveling lane TL when the host vehicle is traveling on a straight road and no preceding vehicle is present. Further, the condition for overlapping the second portion CL1b with the traveling lane TL may include the presence or absence of an oncoming vehicle.

In addition, the low-beam unit 2 may be disposed on each of the left and right sides of the host vehicle. In this case, only the low-beam unit 2 located on the side, to which the low-beam unit 2 is swiveled when the host vehicle transitions to traveling on a straight road, may be swiveled. For example, since the low-beam unit 2 is swiveled to the left in the example illustrated in FIGS. 6A and 6B, the low-beam unit 2 disposed on the left side is swiveled. Thereby, the movable range of each low-beam unit 2 may be set within a structurally unreasonable range. Further, the low-beam unit 2 that is not swiveled in this control may be used, for example, for light irradiation in a traveling direction while the host vehicle is traveling on a curved road.

The embodiments of the present disclosure have been described above in detail. The above-described embodiments are merely specific examples for carrying out the present disclosure. The contents of the embodiment do not limit the technical scope of the present disclosure, and many design modifications, including changes, additions, or deletions of components, may be made without departing from the spirit of the present disclosure as defined in the claims. New embodiments resulting from design changes combine the effects of the embodiments and modifications that are combined. In the above-described embodiments, matters for which such design changes are possible are emphasized by expressions such as “in the present embodiment” or “in this embodiment,” but design changes are also permitted for matters not accompanied by such expressions. Any optional combination of the above-described components is also valid as an aspect of the present disclosure. The hatching applied to cross-sections in the drawings does not limit the material of the hatched objects.

### Modification 1

The height switching of the traveling-lane-side cutoff line CL1 may be implemented by a combination of the additional pattern forming unit 10 of Embodiment 1 and the swivel actuator 26 of Embodiment 2. That is, the additional pattern forming unit 10 forms the additional light distribution pattern AP regardless of the traveling state of the host vehicle. However, while the host vehicle is stopped, the light irradiation direction of the additional pattern forming unit 10 is set such that the additional light distribution pattern AP is positioned outside the traveling lane TL. Then, while the host vehicle transitions to traveling on a straight road, the swivel actuator 26 swivels the additional pattern forming unit 10, thereby moving the additional light distribution pattern AP to a position overlapping with the traveling lane TL. Thereby, the traveling-lane-side cutoff line CL1 may be set to the first height H1 while the host vehicle is stopped, and at the second height H2 while the host vehicle is traveling on a straight line.

### Modification 2

The additional light distribution pattern AP may have a shape that differs from the reference low-beam light distribution pattern Lpa only in the height of the traveling-lane-side cutoff line CL1. That is, the additional light distribution pattern AP may include a diffusion pattern, the traveling-lane-side cutoff line CL1 at the second height H2, the opposing-lane-side cutoff line CL2, and the oblique cutoff line CL3. In this case, the reference low-beam light distribution pattern LPa may be formed while the host vehicle is stopped, and the additional light distribution pattern AP may be formed, instead of the reference low-beam light distribution pattern LPa, while the host vehicle is traveling in a straight line.

### Others

The low-beam unit 2 may include a plurality of light sources arranged in a matrix form. In this case, the height of the traveling-lane-side cutoff line CL1 may be switched by turning on and off the respective light sources. Further, the low-beam unit 2 may have a matrix-type pattern forming device such as a digital mirror device (DMD) or a liquid crystal device, or may have a scanning optical pattern forming device that scans the front of the host vehicle with light from a light source.

In the embodiments, as an example, the control device 6 is configured with a lamp ECU, and the vehicle control device 16 is configured with a vehicle ECU, but the configurations of the respective control devices are not limited thereto. For example, an ECU that functions as one of the control devices may function as all or part of the other control device.

The disclosure according to the above-described embodiments may be specified by the items described below.

### [Item 1]

A vehicle lamp system 1 comprising:
a low-beam unit 2 capable of forming a low-beam light distribution pattern LP having a traveling-lane-side cutoff line CL1, a position of which in a vehicle width direction overlaps with a traveling lane TL of a host vehicle; and
a control device 6 configured to control light irradiation by the low-beam unit 2,
wherein the control device 6 controls the low-beam unit 2 such that the traveling-lane-side cutoff line CL1 is set to a first height H1 while the host vehicle is stopped, and the traveling-lane-side cutoff line CL1 is set to a second height H2 higher than the first height H1 while the host vehicle is traveling on a straight road.

### [Item 2]

The vehicle lamp system 1 according to Item 1, wherein the low-beam unit 2 includes:
a low-beam forming unit 8 configured to form a reference low-beam light distribution pattern LPa having the traveling-lane-side cutoff line CL1 positioned at the first height H1; and
an additional pattern forming unit 10 configured to form an additional light distribution pattern AP having the traveling-lane-side cutoff line CL1 positioned at the second height H2, and
wherein the control device 6 controls the low-beam forming unit 8 such that the reference low-beam light distribution pattern LPa is formed while the host vehicle is stopped and while the host vehicle is traveling, and controls the additional pattern forming unit 10 such that the additional distribution pattern AP is not formed while the host vehicle is stopped, and the additional distribution pattern AP is formed while the host vehicle is traveling on a straight road.

### [Item 3]

The vehicle lamp system 1 according to Item 1, wherein the low-beam unit 2 includes a swivel actuator 26 configured to displace a light irradiation direction in the vehicle width direction, and forms the low-beam light distribution pattern LP having the traveling-lane-side cutoff line CL1 that includes a first portion CL1a positioned at the first height H1 and a second portion CL1b that is shifted from the first portion CL1a in the vehicle width direction and positioned at the second height H2, and
wherein the control device 6 controls the swivel actuator 26 such that a position of the first portion CL1a in the vehicle width direction overlaps with the traveling lane TL while the host vehicle is stopped, and a position of the second portion CL1b in the vehicle width direction overlaps with the traveling lane TL while the host vehicle is traveling on a straight road.

### [Item 4]

The vehicle lamp system 1 according to any one of items 1 to 3, wherein the control device 6 controls the low-beam unit 2 such that the traveling-lane-side cutoff line CL1 is set to the second height H2 when the host vehicle is traveling on a straight road and no preceding vehicle is present.

### [Item 5]

A control device 6 configured to control light irradiation by a low-beam unit 2 capable of forming a low-beam light distribution pattern LP having a traveling-lane-side cutoff line CL1, a position of which in a vehicle width direction overlaps with a traveling lane TL of a host vehicle,
wherein the control device 6 controls the low-beam unit 2 such that the traveling-lane-side cutoff line CL1 is set to a first height H1 while the host vehicle is stopped, and the traveling-lane-side cutoff line CL1 is set to a second height H2 higher than the first height H1 while the host vehicle is traveling on a straight road.

### [Item 6]

A non-transitory computer-readable storage medium having stored therein a computer program executed by a control device 6 that controls light irradiation by a low-beam unit 2 capable of forming a low-beam light distribution pattern LP having a traveling-lane-side cutoff line CL1, a position of which in a vehicle width direction overlaps with a traveling lane TL of a host vehicle,
wherein the computer program causes the control device 6 to execute a function of controlling the low-beam unit 2 such that the traveling-lane-side cutoff line CL1 is set to a first height 1 while the host vehicle is stopped, and the traveling-lane-side cutoff line CL1 is set to a second height 2 higher than the first height 1 while the host vehicle is traveling on a straight road.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A vehicle lamp system comprising:
a low-beam unit including a light source configured to form a low-beam light distribution pattern having a traveling-lane-side cutoff line, a position of which in a vehicle width direction overlaps with a traveling lane of a host vehicle; and
a control device including a processor configured to control a light irradiation by the low-beam unit,
wherein the control device controls the low-beam unit such that the traveling-lane-side cutoff line is set to a first height while the host vehicle is stopped, and the traveling-lane-side cutoff line is set to a second height higher than the first height while the host vehicle is traveling on a straight road.

2. The vehicle lamp system according to claim 1, wherein the low-beam unit includes:
a low-beam forming unit including the light source configured to form a reference low-beam light distribution pattern having the traveling-lane-side cutoff line positioned at the first height; and
an additional pattern forming unit including a lens configured to form an additional light distribution pattern having the traveling-lane-side cutoff line positioned at the second height, and
wherein the control device controls the low-beam former such that the reference low-beam light distribution pattern is formed while the host vehicle is stopped and while the host vehicle is traveling, and controls the additional pattern former such that the additional distribution pattern is not formed while the host vehicle is stopped, and the additional distribution pattern is formed while the host vehicle is traveling on a straight road.

3. The vehicle lamp system according to claim 1, wherein the low-beam unit includes a swivel actuator configured to displace a light irradiation direction in the vehicle width direction, and forms the low-beam light distribution pattern having the traveling-lane-side cutoff line that includes a first portion positioned at the first height and a second portion that is shifted from the first portion in the vehicle width direction and positioned at the second height, and
wherein the control device controls the swivel actuator such that a position of the first portion in the vehicle width direction overlaps with the traveling lane while the host vehicle is stopped, and a position of the second portion in the vehicle width direction overlaps with the traveling lane while the host vehicle is traveling on a straight road.

4. The vehicle lamp system according to claim 1, wherein the control device controls the low-beam unit such that the traveling-lane-side cutoff line is set to the second height when the host vehicle is traveling on a straight road and no preceding vehicle is present.

5. A control device that controls a light irradiation by a low-beam unit capable of forming a low-beam light distribution pattern having a traveling-lane-side cutoff line, a position of which in a vehicle width direction overlaps with a traveling lane of a host vehicle,
wherein the control device controls the low-beam unit such that the traveling-lane-side cutoff line is set to a first height while the host vehicle is stopped, and the traveling-lane-side cutoff line is set to a second height higher than the first height while the host vehicle is traveling on a straight road.

6. A non-transitory computer-readable storage medium having stored therein a computer program executed by a control device that controls light irradiation by a low-beam unit capable of forming a low-beam light distribution pattern having a traveling-lane-side cutoff line, a position of which in a vehicle width direction overlaps with a traveling lane of a host vehicle,
wherein the computer program causes the control device to execute a function of controlling the low-beam unit such that the traveling-lane-side cutoff line is set to a first height while the host vehicle is stopped, and the traveling-lane-side cutoff line is set to a second height higher than the first height while the host vehicle is traveling on a straight road.
